(19) United States
(12) Patent Application Publication
(10) Pub. No.: US 2025/0210919 A1
(43) Pub. Date: Jun. 26, 2025

(54) POWER PROTECTION COMPONENT

(71) Applicant: Chroma ATE INC., Taoyuan (TW)

(72) Inventors: Chih-Yuan CHANG, Taoyuan (TW); Chong-Lin LIU, Taoyuan (TW); Wen-Chih CHEN, Taoyuan (TW)

(21) Appl. No.: 18/966,981

(22) Filed: Dec. 3, 2024

(30) Foreign Application Priority Data
Dec. 27, 2023 (TW) 112214233

(51) Int. Cl. H01R 13/6591; H01F 27/24; H01F 27/36

(52) U.S. Cl. CPC H01R 13/6591; H01F 27/24; H01F 27/36

(57) ABSTRACT

A power protection component is used for being assembled on a host. The power protection component includes a protective housing and an iron core. The protective housing is fixed on the outside of the host. The protective housing comprises an accommodating chamber, a first opening and a second opening. The accommodating chamber is located within the protective housing, and the first opening and the second opening are respectively formed on different sides of the protective housing. The iron core is fixed within the accommodating chamber, and the iron core comprises a perforating hole. After the power cord passes through the second opening and the perforating hole, the power cord is plugged into the plug-in position and forms an inductor with the iron core. The inductor can be used to suppress electromagnetic interference.

### CROSS-REFERENCE TO RELATED APPLICATIONS

This non-provisional application claims priority under 35 U.S.C. § 119(a) on Patent Application No(s). 112214233 filed in Taiwan, on Dec. 27, 2023, the entire contents of which are hereby incorporated by reference.

### TECHNICAL FIELD

This invention relates to a power protection component, which is assembled in any electronic equipment with an external power supply, to prevent the electronic equipment from being affected by electromagnetic interference, or to avoid the external impact of electromagnetic interference generated when operating the electronic equipment.

### DESCRIPTION OF THE RELATED ART

Electromagnetic Interference (EMI) is an electromagnetic phenomenon that causes a degradation in the performance of electronic equipment, devices, or systems (hereinafter referred to only as electronic equipment), or that may adversely affect organisms or substances.

Electromagnetic interference is conductive, and it is generated by the action of voltage and current in any conduction (or electromagnetic field). In other words, any electronic equipment will produce conductive electromagnetic interference. The power cord of the electronic equipment is one of the conduction paths. Generally, the method of suppressing electromagnetic interference is to install components for suppressing electromagnetic interference in the electronic equipment, such as common-mode inductors, X capacitors or Y capacitors, etc. With these components, electromagnetic interference from the electronic equipment can be suppressed from being transmitted to the outside through the power cord, and electromagnetic interference from the outside can be suppressed from being transmitted to the electronic equipment through the power cord.

With the development and progress of science and technology, the demand for power density used in electronic equipment has also increased accordingly, which leads to the compression of the internal space of electronic equipment. Under the condition of the limited internal space of electronic equipment, it is difficult to install additional components to suppress electromagnetic interference. Especially, among the above-mentioned components for suppressing electromagnetic interference, the common-mode inductor has the best suppression effect on electromagnetic interference. However, the common-mode inductor is larger than the X capacitor or Y capacitor. Although the X capacitor or Y capacitor is smaller than the common-mode inductor, the X capacitor or Y capacitor has poor suppression effect on electromagnetic interference.

Briefly speaking, the limited space inside the electronic equipment does not allow for the installation of common-mode inductors. Although X capacitors or Y capacitors can be installed, X capacitors or Y capacitors have limited suppression effect and cannot effectively improve the problem of electromagnetic interference.

### BRIEF SUMMARY OF THE UTILITY MODEL

Due to safety regulations, electronic equipment must be equipped with a protective housing. In this way, the protective housing is used as a carrier to install components for suppressing electromagnetic interference. In addition to complying with safety regulations, it can also suppress electromagnetic interference and does not need to be limited by the use space. This is the solution created by this invention.

The power protection component of the present invention is used to be assembled on a host. The host has a plug-in position on the outside. The plug-in position is electrically connected to a power cord, and the power cord is electrically connected to an external power supply.

The power protection component of the invention includes a protective housing and an iron core. The protective housing is fixed on the outside of the host and covers the plug-in position. The protective housing has an accommodating chamber, a first opening and a second opening, and the accommodating chamber is located within the protective housing. The first opening and the second opening are respectively formed on different sides of the protective housing, and the opening direction of the first opening is toward the plug-in position. The iron core is fixed within the accommodating chamber, and the iron core has a perforating hole. After the power cord passes through the second opening and the perforating hole, it is then plugged into the plug-in position and forms an inductor with the iron core.

Accordingly, the inductor can be used to suppress electromagnetic interference, thereby preventing external electromagnetic interference from entering the host through the power cord, or preventing electromagnetic interference generated during the operation of the host from being transmitted to the outside through the power cord.

In a preferred embodiment, the iron core is fixed in the accommodating chamber and close to the second opening, and the perforating hole is aligned with a hole position of the second opening.

In a preferred embodiment, an assembly structure is provided on an edge of the first opening, and the assembly structure is used to fix the protective housing on the host.

In a preferred embodiment, the assembly structure comprises a plurality of hook portions, and the hook portions are in a shape of an inverted hook for hooking on the host.

In a preferred embodiment, the assembly structure comprises a plurality of locking portions, the locking portions are arranged on the outside of the protective housing, and each of the locking portions comprises a protective case locking hole, the locking portions can be attached to an outer surface of the host, and can be inserted into the protective case locking holes through a plurality of locking components and then locked into the host.

In a preferred embodiment, the iron core is accommodated within a fixing frame, and the fixing frame is fixed within the protective housing.

In a preferred embodiment, the fixing frame comprises a frame body, a fixing chamber and a through hole, the fixing chamber is located within the frame body, the fixing chamber is used to accommodate the iron core, the through hole passes through the frame body, and position of the through hole corresponds to the perforating hole, so that when the iron core is assembled in the fixing chamber, the through hole is aligned with a hole position of the perforating hole.

In a preferred embodiment, the frame body is assembled from a first frame body and a second frame body, the first frame body is provided with a first buckle structure, the second frame body is provided with a second buckle structure, and the first buckle structure is matched with the second buckle structure.

In a preferred embodiment, the fixing frame is fixed within the accommodating chamber and close to the second opening, and the through hole and the perforating hole are aligned with a hole position of the second opening.

In a preferred embodiment, the protective housing or the fixing frame is made of insulating material.

### BRIEF DESCRIPTION OF THE DRAWINGS

FIG. 1 is a schematic top view of the first embodiment of the power protection component of the present invention.

FIG. 2 is a schematic diagram of a three-dimensional decomposition of the host and the protective housing in the first embodiment of the power protection component of the invention.

FIG. 3 is a schematic diagram of a three-dimensional decomposition of the protective housing and the iron core in the first embodiment of the power protection component of this invention.

FIG. 4 is a schematic cross-sectional view of the host, the protective housing and the iron core in the first embodiment of the power protection component of the invention.

FIG. 5 is a schematic top view of the second embodiment of the power protection component of the present invention.

FIG. 6 is a schematic diagram of a three-dimensional decomposition of the protective housing, the iron core and the fixing frame in the second embodiment of the power protection component of this invention.

FIG. 7 is a schematic cross-sectional view of the host, the protective housing and the iron core in the second embodiment of the power protection component of the invention.

### DETAILED DESCRIPTION OF THE INVENTION

Other technical contents, features and effects of the present invention will be clearly presented in the following detailed description of the preferred embodiment with reference to the drawings.

Unless otherwise defined, all technical and scientific terms used herein have

the same meaning as commonly understood by persons of ordinary skill in the art to which the invention belongs.

As used herein, the terms “first”, “second”, etc. are only used to distinguish the described elements and are not to be construed as indicating or implying relative importance, order of use, or order of arrangement.

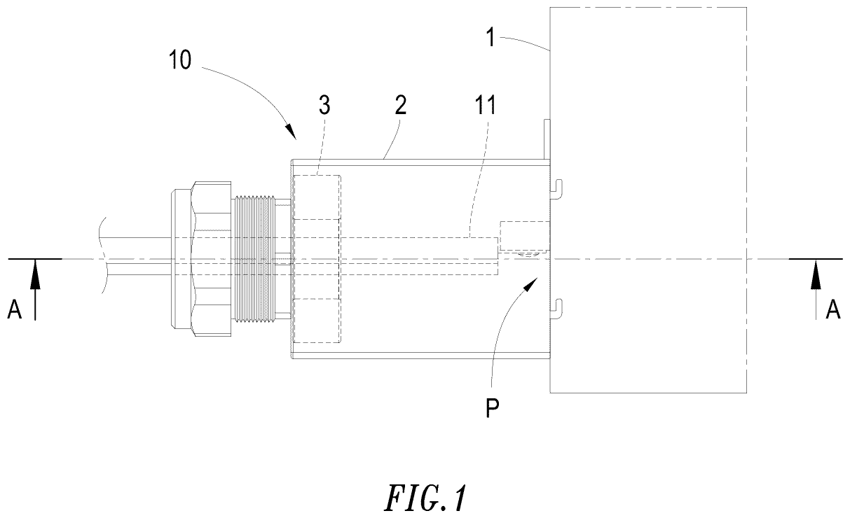

Please refer to FIG. 1. FIG. 1 is a schematic top view of the first embodiment of the power protection component 10 of the present invention. As shown in the figure, the power protection component 10 is used to be assembled outside the host 1. The host 1 can be any electronic equipment with an external power supply (not shown). The electronic equipment can be, for example, but not limited to, a power supply device. The external power supply of the host 1 is connected through the power cord 11. Because electromagnetic interference is generated by the host 1 during operation, the electromagnetic interference will be transmitted to the external power supply through the power cord 11, thereby affecting the external power supply or other hosts. Electromagnetic interference in the power cord 11 is conducted in both directions, and thus electromagnetic interference from external power sources or other hosts will also be conducted to the host 1 through the power cord 11. In order to prevent the host 1 from being affected by electromagnetic interference, or to avoid the external effects of the electromagnetic interference generated during the operation of the host 1, the host 1 is equipped with a power protection component 10 to suppress the electromagnetic interference.

In the first embodiment, the power protection component 10 includes a protective housing 2 and an iron core 3.

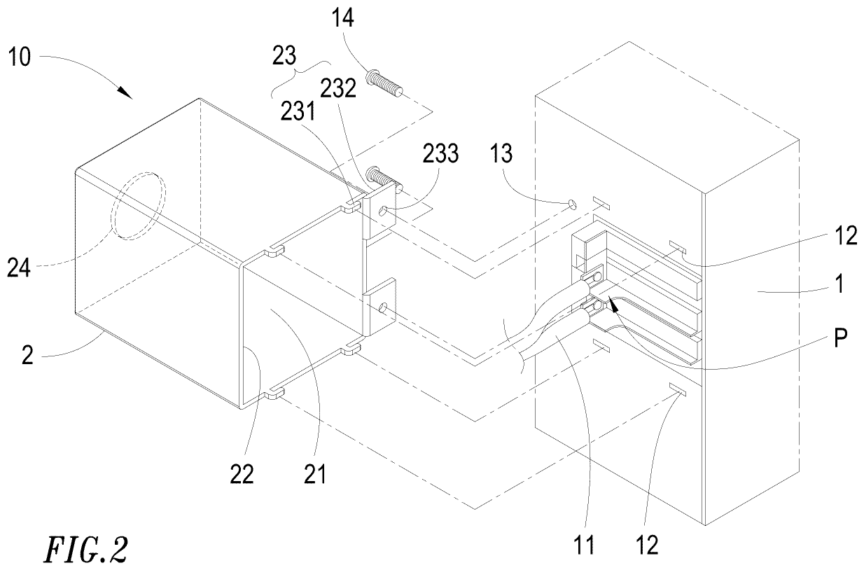

Regarding the design of the protective housing 2, please refer to FIG. 2. FIG. 2 is a schematic diagram of a three-dimensional decomposition of the host 1 and the protective housing 2 in the first embodiment of the invention. As shown in the figure, in the embodiment, the protective housing 2 has an accommodating chamber 21, a first opening 22, an assembly structure 23 and a second opening 24. The accommodating chamber 21 is located inside the protective housing 2. The first opening 22 is formed on the front side of the protective housing 2. The assembly structure 23 is formed on the edge of the first opening 22. The second opening 24 is formed on the back side of the protective housing 2, which is equivalent to the second opening 24 and the first opening 22 being located on opposite sides of the protective housing 2. In other embodiments, the second opening 24 may also be formed any side of the left side, the right side, the upper side, and the lower side of the protective housing 2, as long as the second opening 24 and the first opening 22 are located on two different sides of the protective housing 2, which falls within the scope of the embodiment.

Accordingly, the assembly structure 23 is used to fix the protective housing 2 on the host 1. The opening direction of the first opening 22 is first toward the external position at which the power cord 11 is inserted in the host 1, and then the protective housing 2 is assembled with the host 1 through the assembly structure 23. As shown in the embodiment of FIG. 2, the assembly structure 23 has hook portions 231 and locking portions 232. There are four hook portions 231, among which two hook portions 231 are located above the front side of the first opening 22, and the other two are located below the front side of the first opening 22. Each hook portion 231 is in the shape of an inverted hook to facilitate hooking on the host 1. In practice, the host 1 is provided with four hanging holes 12, and the position of each hanging hole 12 corresponds to each hook portion 231. During assembly, each hook portion 231 is inserted into each of the hanging holes 12, and each of the hook portions 231 is snapped in the direction of inverted hooks, so that each of the hook portions 231 can be hooked on the edge of each of the hanging holes 12. In this way, the protective housing 2 is secured to the host 1 through the combination of the hook portions 231 and the hanging holes 12. In other embodiments, the number of hook portions 231 is at least two or more, and the hook portions 231 can also be disposed on any side of the front side of the first opening 22. The embodiment is not limited to thereto. As long as the hook portion 231 can be secured to the first opening 12, it falls within the scope of the embodiment. There are two locking portions 232, and the locking portions 232 are disposed on the left side of the protective housing 2. Each locking portion 232 has a protective case locking hole 233, each locking portion 232 is used to be affixed to the outer surface of the protective housing 2, and each of the locking portions 232 can be secured to the host 1 through the locking components 14. In practice, the host 1 is provided with a plurality of host locking holes 13, and the position of each host locking hole 13 corresponds to each protective case locking hole 233. The host locking holes 13 are threaded holes, the locking components 14 are screws, and the host locking hole 13 can be locked by the locking components 14. During assembly, each locking portion 232 is attached to the outer surface of the host 1, and each protective case locking hole 233 is aligned with the hole position of each host locking hole 13. Afterwards, the locking component 14 is used to insert into the protective case locking hole 233, and then lock into the host locking hole 13, so that each locking portion 232 can be fixed to the host 1. In other embodiments, the number of locking portions 232 may be more than two, and the locking portions 232 may be disposed on the right side, upper side, or lower side of the protective housing 2. The embodiment is not limited to thereto. As long as the locking portion 232 can be locked on the host locking hole 13 through the locking component 14, it falls within the scope of the embodiment. In addition to the buckling structure through the hook portion 231 and the hanging hole 12, and the thread structure through the locking portion 232, the host locking hole 13 and the locking component 14, in other embodiments, the assembly structure 23 may also be used to secure the protective housing 2 to the host 1 through other detachable structures, such as dowels, quick-release parts, fasteners, or nails, etc. The present embodiment is not limited thereto. As long as the protective housing 2 is detachably secured to the host 1 through the assembly structure 23, it falls within the scope of the present embodiment.

It is worth mentioning that the protective housing 2 is fixed on the outside of the host 1. In particular, the protective housing 2 covers the plug-in position P of the power cord 11 on the host 1. In this way, the exposure of the plug-in position P can be avoided, further preventing people from inadvertently touching the plug-in position P and causing safety accidents.

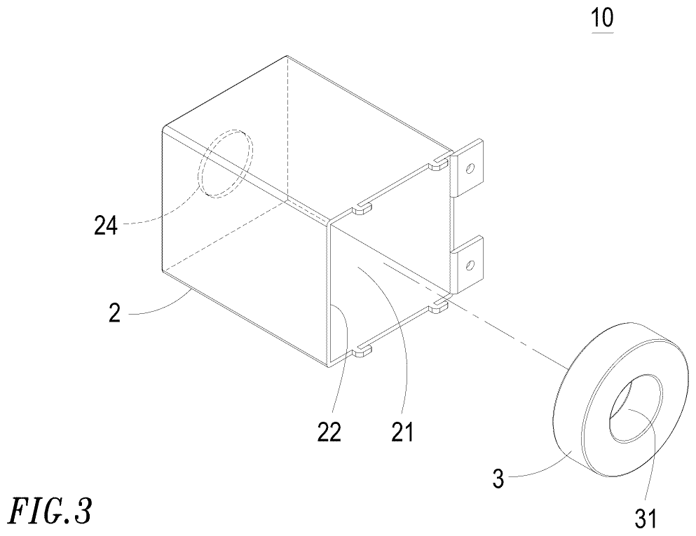

Regarding the design of the iron core 3, please refer to FIG. 3. FIG. 3 is a schematic diagram of a three-dimensional decomposition of the protective housing 2 and the iron core 3 in the first embodiment of the invention. As shown in the figure, in the embodiment, the iron core 3 is a ferrite core. As the name suggests, it is a core made of ferrite. The ferrite is, for example, but not limited to, manganese-zinc ferrite or nickel-zinc ferrite. The iron core 3 is in the shape of a ring with a perforating hole 31 in the center, and the iron core 3 is fixed in the accommodating chamber 21.

Regarding the fixation of the iron core 3 and the accommodating chamber 21, the iron core 3 can be fixed in the accommodating chamber 21 through various structures or media, as long as the iron core 3 and the accommodating chamber 21 will not be easily detached or dropped after being combined, whether it is a fixed connection, a detachable connection, an integral connection, a mechanical connection, or an indirect connection through an intermediate medium, such as any combination method by the use of threads, latches, quick-release parts, buckles, nails or adhesives. The embodiment is not limited to thereto. As long as the iron core 3 is fixed in the accommodating chamber 21 and cannot be easily separated or dropped, it falls within the scope of the embodiment. For safety in use, there is no electrical conduction between the iron core 3 and the protective housing 2, whereby no electrical conduction means that no current passes through the iron core 3 to the protective housing 2. In this way, the protective housing 2 can be prevented from carrying current, which further prevents people from getting electric shock due to touching the protective housing 2. In order to achieve non-conductivity between the iron core 3 and the protective housing 2, in one embodiment, the protective housing 2 is made of insulating material. In other embodiments, structures of other insulating material are combined between the iron core 3 and the protective housing 2, such as but not limited to fixed structures of insulating glue or insulating material.

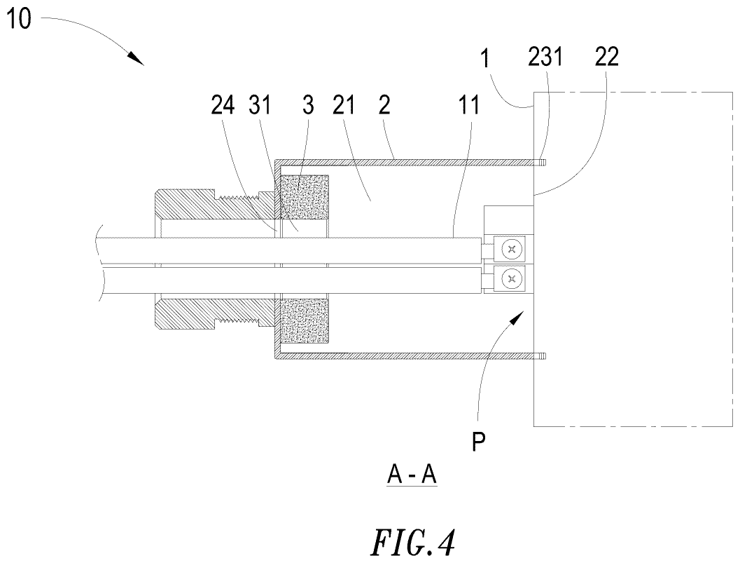

Please refer to FIG. 4. FIG. 4 is a cross-sectional view along the broken line A-A in FIG. 1. The figure is a schematic cross-sectional view of the host 1, the protective housing 2 and the iron core 3 in the first embodiment of the present invention. As illustrated in the figure, the iron core 3 is close to the back side of the protective housing 2, and the perforating hole 31 is aligned with the hole position of the second opening 24. As such, the power cord 11 is allowed to be inserted into the second opening 24 from the outside of the protective housing 2 while the power cord 11 can be inserted into the perforating hole 31 at the same time and then plugged into the host 1. When the power cord 11 passes through the perforating hole 31, the power cord 11 and the iron core 3 form an inductor. The inductor can be used to suppress electromagnetic interference. In this way, external electromagnetic interference can be prevented from entering the host 1 through the power cord 11. Alternatively, the electromagnetic interference generated by the operation of the host 1 can be prevented from being transmitted to the outside through the power cord 11.

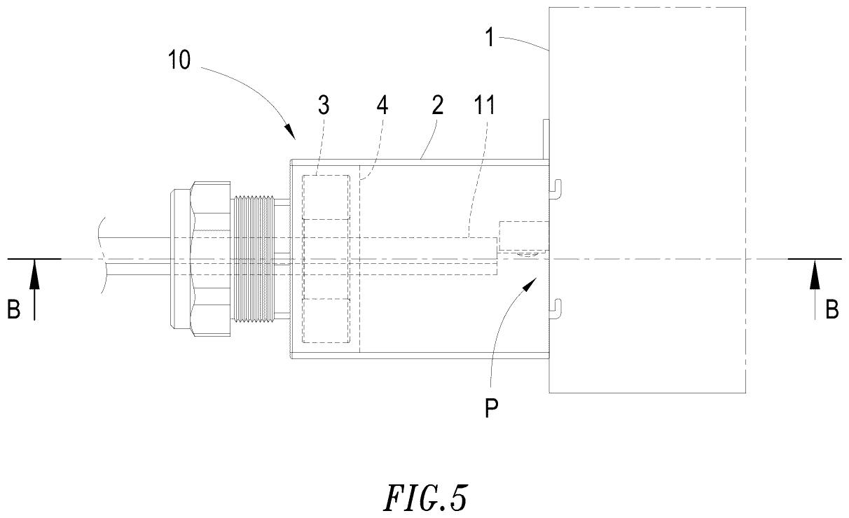

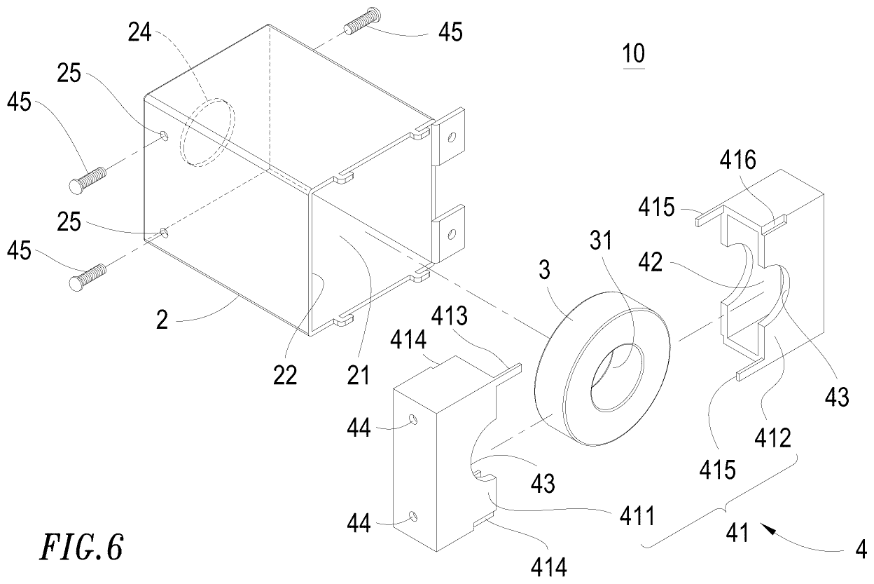

Please refer to FIGS. 5 and 6. FIG. 5 is a schematic diagram of top view of the second embodiment of the invention, and FIG. 6 is a schematic diagram of a three-dimensional decomposition of the second embodiment of the invention. As shown in the figure, the difference between the first embodiments and the second embodiment of the power supply protection assembly 10 is that a fixing frame 4 is also combined between the iron core 3 and the protective housing 2. In the embodiment shown in FIG. 5, the fixing frame 4 includes a frame body 41, a fixing chamber 42, a through hole 43 and a frame fixing hole 44. The fixing chamber 42 is located within the frame body 41, and the fixing chamber 42 is used to accommodate the iron core 3. The through hole 43 penetrates the frame body 41, and its position corresponds to the perforating hole 31, so that when the iron core 3 is assembled in the fixing chamber 42, the through hole 43 is aligned with the hole position of the perforating hole 31. Afterwards, the frame body 41 further includes a plurality of frame body fixing holes 44, and the frame body fixing holes 44 can be locked by the fixing components 45. The protective housing 2 is provided with a plurality of protective case fixing holes 25. The position of each protective case fixing hole 25 corresponds to each frame body fixing hole 44. The frame body fixing holes 44 are threaded holes. During assembly, the fixing frame 4 is placed into the accommodating chamber 21, and each protective case fixing hole 25 is aligned with the hole position of the frame body fixing hole 44. Afterwards, the fixing component 45 is used to first insert into the protective case fixing hole 25 and then lock into the frame body fixing hole 44. In this way, the iron core 3 can be fixed within the protective housing 2 through the fixing frame 4.

In one embodiment, the frame body 41 is assembled from a first frame body 411 and a second frame body 412. The first frame body 411 is provided with a first buckle structure, and the second frame body 412 is provided with a second buckle structure. The first buckle structure can be matched with the second buckle structure. More specifically, the first buckle structure has a first plugin 413 and a first slot 414, the second buckle structure has a second plugin 415 and a second slot 416. The position of the first plugin 43 corresponds to the second slot 416, and the position of the second plugin 415 corresponds to the first slot 414. After the first plugin 413 is inserted into the second slot 416, the first plugin 413 and the second slot 416 are engaged and fixed. Similarly, after the second plugin 415 is inserted into the first slot 414, the second plugin 415 and the first slot 414 are engaged and fixed. In this way, by engaging and fixing the first buckle structure and the second buckle structure, the first frame body 411 and the second frame body 412 can be effectively combined. In addition to the buckle structure, in other embodiments, the first frame body 411 and the second frame body 412 can also be assembled through other detachable structures, such as threads, latches, quick-release parts, buckles or nails, etc. The embodiment is not limited to thereto. As long as the first frame body 411 and the second frame body 412 are detachably assembled, it falls within the scope of the embodiment.

In order to meet the security requirements as described above, the fixing frame 4 may be made of insulating material. In this way, the iron core 3 can be fixed between the protective housing 2 through the fixing frame 4 without conducting electricity, so as to prevent the protective housing 2 from carrying electric current.

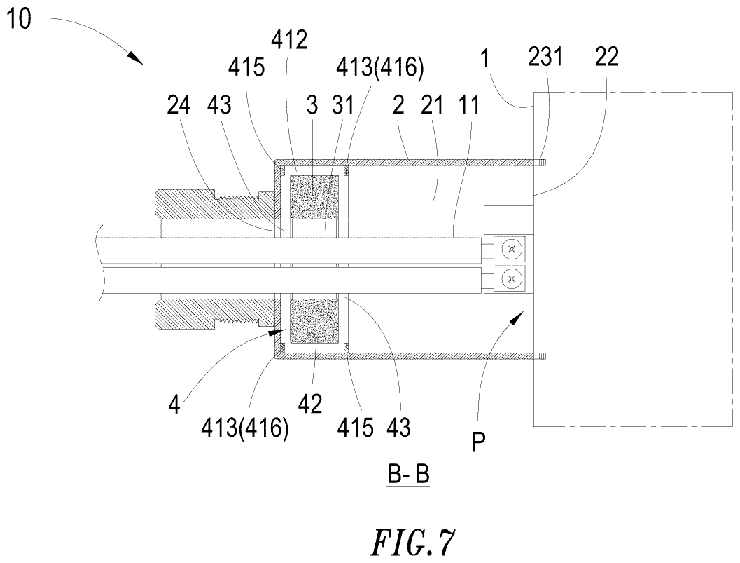

Please refer to FIG. 7. FIG. 7 is a cross-sectional view along the broken line B-B in FIG. 5. The figure is a schematic cross-sectional view of the host 1, the protective housing 2, the iron core 3 and the fixing frame 4 in the second embodiment of the present invention. As illustrated in the figure, the fixing frame 4 is close to the back side of the protective housing 2. The through hole 43 and the perforating hole 31 are aligned with the hole position of the second opening 24. As such, the power cord 11 is allowed to be inserted into the second opening 24 from the outside of the protective housing 2 while the power cord 11 can be inserted into the through hole 43 and the perforating hole 31 at the same time and then plugged into the host 1. When the power cord 11 passes through the perforating hole 31, the power cord 11 and the iron core 3 form an inductor. The inductor can be used to suppress electromagnetic interference. In this way, external electromagnetic interference can be prevented from entering the host 1 through the power cord 11. Alternatively, the electromagnetic interference generated by the operation of the host 1 can be prevented from being transmitted to the outside through the power cord 11.

It is worth mentioning that each additional iron core 3 can form an additional inductor. Each additional inductor increases the effect of suppressing electromagnetic interference.

Based on the foregoing, compared with other conventional technologies, the power protection component 10 provided by the invention provides the following advantages:

A. In order to comply with safety regulations, the host 1 must be provided with a protective housing 2. The protective housing 2 is used to protect the power cord 11, so that the power cord 11 is not exposed to further prevent people from accidentally touching the plug-in position P of the power cord 11 and comply with the safe usage requirements. The protective housing 2 has a certain amount of space for accommodating the iron core 3. Therefore, while using the protective housing 2 to comply with safety regulations, the iron core 3 can be fixed in the protective housing 2 simultaneously, and efficient use of space inside the protective housing 2 can be achieved to avoid wasting space.
B. After the power cord 11 passes through the perforating hole 31 of the iron core 3, an inductor can be formed to suppress electromagnetic interference. In this way, external electromagnetic interference can be prevented from entering the host 1 through the power cord 11. Alternatively, the electromagnetic interference generated by the operation of the host 1 can be prevented from being transmitted to the outside through the power cord 11.

The above examples are only a selection of some of the better embodiments of the invention, but they are not intended to limit the invention. Any person who is familiar with the general knowledge in this technical field and understands the aforesaid technical features and embodiments of the present invention, and makes equal variations or embellishments within the spirit and scope of the present invention, shall still fall within the scope of the utility model application. The scope of patent protection for the invention shall be as defined in the claim attached hereto.

What is claimed is:

1. A power protection component, assembled on a host, wherein an outside of the host comprises a plug-in position, the plug-in position is electrically connected to a power cord, and the power cord is electrically connected to an external power supply, the power protection component comprising:
a protective housing, fixed on the outside of the host and covering the plug-in position, wherein the protective housing comprises an accommodating chamber, a first opening and a second opening, the accommodating chamber is located within the protective housing, the first opening and the second opening are respectively formed on different sides of the protective housing, and opening direction of the first opening is toward the plug-in position; and
an iron core, fixed within the accommodating chamber, wherein the iron core comprises a perforating hole so that no electrical conductivity is provided between the iron core and the protective housing;
wherein after the power cord passes through the second opening and the perforating hole, the power cord is plugged into the plug-in position and forms an inductor with the iron core.

2. The power protection component according to claim 1, wherein the iron core is fixed in the accommodating chamber and close to the second opening, and the perforating hole is aligned with a hole position of the second opening.

3. The power protection component according to claim 1, wherein an assembly structure is provided on an edge of the first opening, and the assembly structure is used to fix the protective housing on the host.

4. The power protection component according to claim 3, wherein the assembly structure comprises a plurality of hook portions, and the hook portions are in a shape of an inverted hook for hooking on the host.

5. The power protection component according to claim 3, wherein the assembly structure comprises a plurality of locking portions, the locking portions are arranged on the outside of the protective housing, and each of the locking portions comprises a protective case locking hole, the locking portions can be attached to an outer surface of the host, and can be inserted into the protective case locking holes through a plurality of locking components and then locked into the host.

6. The power supply protection component according to claim 1, wherein the iron core is accommodated within a fixing frame, and the fixing frame is fixed within the protective housing.

7. The power protection component according to claim 6, wherein the fixing frame is made of insulating material.

8. The power supply protection component according to claim 6, wherein the fixing frame comprises a frame body, a fixing chamber and a through hole, the fixing chamber is located within the frame body, the fixing chamber is used to accommodate the iron core, the through hole passes through the frame body, and position of the through hole corresponds to the perforating hole, so that when the iron core is assembled in the fixing chamber, the through hole is aligned with a hole position of the perforating hole.

9. The power protection component according to claim 8, wherein the frame body is assembled from a first frame body and a second frame body, the first frame body is provided with a first buckle structure, the second frame body is provided with a second buckle structure, and the first buckle structure is matched with the second buckle structure.

10. The power protection component according to claim 8. wherein the fixing frame is fixed within the accommodating chamber and close to the second opening, and the through hole and the perforating hole are aligned with a hole position of the second opening.
